(19) United States
(12) Patent Application Publication
(10) Pub. No.: US 2010/0169958 A1
(43) Pub. Date: Jul. 1, 2010

(54) Method for generating and using composite scene passcodes

(75) Inventors: Steffen Werner, Moscow, ID (US); Sergio P. Caltagirone, Olney, MD (US); Korey R. Johnson, Oakbrook Terrace, IL (US)

Correspondence Address: KLARQUIST SPARKMAN, LLP, 121 SW SALMON STREET, SUITE 1600, PORTLAND, OR, 97204, US

(73) Assignee: Univeristy of Idaho

(21) Appl. No.: 12/311,304

(22) PCT Filed: Oct. 15, 2007
(86) PCT No.: PCT/US07/22042

§ 371 Date: Mar. 23, 2009

Related U.S. Application Data
(60) Provisional application No. 60/851,695, filed on Oct. 13, 2006.

(51) Int. Cl. H04L 9/32; G06F 17/30; G06F 17/40

(52) U.S. Cl. 726/6; 726/7; 713/183; 713/184; 726/18; 726/19

(57) ABSTRACT

One disclosed embodiment for creating a composite scene passcode comprises presenting a system-generated composite scene passcode to a user, allowing the user to generate a composite-scene passcode by selecting one scene element per scene dimension, or allowing the user to enter an alphanumeric password that encodes the composite scene passcode. Certain embodiments also comprise combining the passcode with an alphanumeric password. The composite scene may be two dimensional, three dimensional, or greater than three dimensions, and/or the scene may be animated. A computer system using a composite scene passcode also is disclosed. One embodiment of the system comprises a display for displaying a composite scene passcode or plural scene dimensions for generating the composite scene passcode. Authentication may comprise using scene elements arranged categorically and requiring the user to select the correct scene element from among distracter elements within the same category. The system may also include an input device.

### CROSS-REFERENCE TO RELATED APPLICATIONS

This application claims the benefit of U.S. Provisional Application No. 60/851,695 filed on Oct. 13, 2006. The entire disclosure of the provisional application is considered to be part of the disclosure of the following application and is hereby incorporated by reference.

### FIELD

Disclosed embodiments of the present invention concern a system and process for generating and using composite scene passcodes.

### BACKGROUND

### A. Passwords Generally

Computer systems frequently process and store sensitive information. Computers are increasingly interconnected via networks such as the Internet. Concomitantly, unauthorized access to computers and information also has increased. Using passwords to control access to computers, databases, telecommunications facilities, etc., is well known. A user is required to enter a user identification (userID) and a valid password to ensure that the user is authorized to access the resource. The majority of current user authentication mechanisms are based on alphanumeric passwords. See, for example, Renaud & De Angeli, 2004; Jermyn, et al., 1999. The password is entered using any appropriate input device, such as keying the character in on a terminal or a telephone keyboard. The inputted character strings are compared with userID character strings and associated password character strings stored in memory or at another, connected server (e.g., in a lookup table or other data base). If the inputted password character strings match the password character strings linked to the particular userID stored in memory, the user is then granted access to data and/or allowed to execute programs via the computer system.

Conventional alphanumeric passwords often are difficult to remember, particularly if they are arbitrary alphanumeric sequences. Alphanumeric passwords are relatively easy to compromise, particularly using computers programmed to automatically try all permutations in an attempt to gain unauthorized access to a resource and exploiting the tendency of humans to choose easily predictable passwords. Once a password has been compromised, it subsequently can be used over and over again until the breach is discovered. Also, identification and authentication data can be stolen by monitoring keystrokes on a keyboard.

Recently developed, alternative security arrangements rely on determining a user's individual characteristics, such as by using voice analyzers, retina scanners, fingerprint image analyzers, face image analyzers or other biometric data to validate the user's identity. While sometimes effective, these security approaches also have disadvantages, including complexity to implement, maintain, and associated cost. In addition, a compromised biometric passcode can not easily be replaced, as it is usually directly and irrevocably tied to the physical makeup of a user. Other alternatives, such as token-based authentication mechanisms, rely on the availability of physical tokens or keys as external means to store complex passcodes. However, these items can be lost, stolen, or otherwise compromised to reduce their value as a secure authentication mechanism.

### B. Remembering Passwords

While high security demands long, arbitrary sequences of elements to increase passcode complexity, humans are good at remembering short and meaningful sequences of elements. Thus, security demands are inversely related to the ability of humans to remember passwords (Adams, et al., 1997; Adams & Sasse, 1999; De Angeli, et al., 2005). If users create their own passwords, they are most likely to choose a password that is easy to remember rather than one that is secure. Alternatively, the user will remember the password using techniques that compromise the enhanced security associated with relatively long and randomly selected alphanumeric passcodes. For example, a user might keep a PIN number with them or might write a computer system password down and keep it adjacent to the computer for which the password is intended.

The inverse relationship between the ability of humans to remember passcodes and security creates a need for alternatives to alphanumeric passwords. Graphical authentication mechanisms, which use pictorial material as elements of the passcode, have been proposed for improving passcode memorability. See, for example, Passfaces, by Real User Corporation, which uses pictures of faces as its passcode; Déjà vu (Dhamija & Perrig, 2000: Déjà vu: A user study using images for authentication. In Proceedings of the 9^{th} USENIX Security Symposium, Denver, Colo.), which uses random art images (Bauer, 1998: Gallery of random art. WWW at http://andrej.com/art/); and The Visual Identification Protocol (VIP) system (De Angeli, et al., 2005: Is a picture really worth a thousand words? Exploring the feasibility of graphical authentication systems. International Journal of Human Computer Studies, 63, 128-152), which uses randomly assigned (and unrelated) photographic images of objects and scenes to build a passcode.

Surprisingly, few studies concerning graphical passcodes show a substantial improvement in memorability over traditional alphanumeric passwords. In addition, previous studies on graphical authentication have mainly focused on short passcodes of 10-13 bits. While this passcode length is similar to the current 4-digit authentication codes of ATM machines, it usually is not considered a secure password length and likely does not tap the full potential of graphical passcodes.

### C. Patented Password Generation Schemes

Password generating methods also have been patented, including graphical methods. For example, U.S. Pat. No. 5,559,961, entitled Graphical Password, discloses using an image as the basis for defining a sequence, of so called tap regions within a two-dimensional display surface. FIG. 4 of the ×961 patent, which is an image of a horse's head, provides one example of a method for generating a graphical password. The user is presented with one or more images and has to remember a sequence of tap regions to tap in. Authentication with this system requires the user to re-enter the sequence of taps as a means to enter the user's passcode. The image may serve as a reminder of the locations that need to be tapped. This approach is referred to as “locimetric authentication” because it relies solely on the screen position tapped.

There are several deficiencies associated with the locimetric approach. First, the spot selection, if it is user-generated, is not random, but instead is highly predictable using simple algorithms. This substantially limits the complexity of the password. If the regions are arbitrarily selected within the display space, common memory biases that have been widely reported in the spatial cognition literature, will lead to a distortion of some to-be-remembered tap locations, which will render the passcode system highly error-prone (e.g., Werner & Diedrichsen, 2002: The time course of spatial memory distortions. Memory and Cognition, 30, 718-730). Second, even though the image itself, e.g. the horse's head, might itself be easily remembered or recognized, particularly if item imaged is well known to the user, the sequence of taps is inherently arbitrary (except for the tendency of users to choose similar sequences). Moreover, nothing in the image cues the participant to recall the correct tap locations and sequence in which they are tapped. Thus, the cognitive mechanism used requires remembering an arbitrary sequence of taps over a known image. The main goal of a graphical authentication system, to increase memorability and to decrease cognitive effort in remembering complex passcodes, is thus not sufficiently met by the invention described in the '961 patent.

As another example, U.S. Pat. No. 6,934,860, entitled “System, Method and Article of Manufacture for Knowledge-based Password Protection of Computers and other Systems,” also discloses using an image or images to develop a passcode. This process uses a number of arbitrary image elements arranged in a two-dimensional image plane. During authentication, users have to perform particular actions (gestures) on the image elements/icons.

U.S. patent application No. 20040230843 entitled “System and Method for Authenticating Users using Image Selection” also discloses using individual images for authenticating a user's identity. In this approach, similarly to the one described above for the '860 patent, the user selects and learns a set of individual thumbnail images out of a set of a plurality of images that is displayed as a matrix of thumbnail images. During authentication, the sequence of images has to be recalled and selected by the user.

Both of these approaches are tiling approaches. Usually different image elements (e.g., icons, pictures, etc.) are depicted on a screen in a tiled manner, i.e. a set of arbitrarily jumbled picture elements/icons are presented and often are arranged in a regular matrix. Arbitrary actions (in the simplest case a selection of the image) have to be remembered in relation to the image elements. As before, these approaches do not take advantage of the full potential of a users' ability to remember visual information. Moreover, these approaches further require that the user remember arbitrary sequential information to enter the passcode.

### SUMMARY

Prior known password generating methods are inadequate to provide the security required given the constraints of human long-term memory. Alphanumeric passwords of sufficient complexity are too difficult to remember easily leading users to write down passwords and to compromise security. And prior graphical implementations do not sufficiently address the retention problem. For example, the approach disclosed in the '961 patent presents a single image or sequence of images. “Tap regions” in the image are tapped to generate the passcode. Only a single image is presented at each time, and there seemingly is no relationship between the tap regions that a user taps to generate the password, making it difficult for a user to remember the exact sequence. Similarly, although the '860 patent does use plural images, there is absolutely no relationship between the images that can be selected by the user. Both approaches are based on the assumption that visual material can be better remembered than verbal or other symbolic information.

However, memory for detailed visual information is not boundless, as is often thought, but severely limited (e.g., O'Regan, 1992: Solving the “real” mysteries of visual perception: the world as an outside memory. Canadian Journal of Psychology. 46(3), 461-88). Pictures do, however, allow rapid access to meaning and the gist of pictorial information can be processed very quickly. The gist of a scene is then combined with distinct visual elements to provide a rich memory representation (Potter, et al., 2002: Recognition memory for briefly presented pictures: The time course of rapid forgetting. Journal of Experimental Psychology: Human Perception and Performance, 28(5), 1163-1175). In previous approaches, pictorial information was presented as separate visual images. As research on mental imagery and picture memory has shown, interactivity and meaningful context often leads to an increase in processing and memorability of visual information. As a result, the user must rely on memory for the individual images, without any benefit from potential interactions among the depicted elements.

Disclosed embodiments can address deficiencies of the prior approaches. For example, certain embodiments of the present invention concern particular positioning of scene elements on a background. A “scene” is created with the intention of suggesting to the viewer a certain narrative or meaning that includes the scene elements. Through the arrangement of the scene elements, particular interrelations and interactions between objects are created that are qualitatively different from assembling an image using unrelated image tiles. In many instances the created scenes might be “realistic” in that they depict common objects in traditional settings. However, realism or plausibility of a narrative is not a precondition for meaningful scenes. Strange scenes, such as a tiger balancing a penguin on its nose while licking ice-cream in the arctic might not be plausible, but they clearly suggest an easily understandable narrative of what is happening in the scene and thus create strong interrelations and interactions between the scene elements (in this case the tiger, penguin, ice-cream, and the arctic background).

Unlike previous approaches, the present invention focuses on an optimization of the visual material for human users' memory demands, instead of focusing on the ease of passcode generation of a tiled set of unrelated images. In addition, certain disclosed embodiments of the present invention concern combining graphical passcodes with verbal or other non-verbal information to enhance the memorability of the visual material or to introduce redundancy in coding.

One embodiment of the present invention for selecting a passcode comprises presenting a user with scene elements for each scene dimension used to compose a password. The user then, randomly selects one element for each scene dimension. The composite scene passcode is then assembled using elements selected by the user for each scene dimension presented. Another embodiment relies on the random generation of a composite scene through a computer system to increase security. Another embodiment for selecting or authenticating a passcode comprises sequentially selecting an initial (for generating a passcode) or the correct (for authenticating a user) element from each set of distracter elements, where all of the elements presented in a particular set are within a single category (e.g. all presented elements in a particular set are adult males).

Another embodiment of the present invention combines the strengths of traditional passwords with the increased memorability of graphical passcodes by pairing the two, either to increase overall passcode length or to create redundancy between the two. This redundancy allows users who have forgotten an alphanumeric password to rely on their superior memory for the graphical passcode to retrieve the alphanumeric password, while at the same time allowing for fast alphanumeric password entry whenever possible. Finally, an embodiment of the present invention includes textual or verbal information to aid the user in creating a rich memory representation of the visual scene. This additional information takes advantage of the dual coding ability within human memory (Paivio, 1971).

The composite scene may be a two dimensional scene, and the scene may be animated. In certain disclosed embodiments, individual scene elements may be placed into the composite scene at predefined x,y-image locations. Dependencies between scene elements and scene element placement constraints may be stored in a database. Alternatively, dependencies or general rules may be inferred or determined by the system or an algorithm. Examples of constraints include, by way of example, location of the scene element, orientation of the scene element, relative size of a scene element, interposition, aerial perspective, texture gradients, and combinations thereof. In certain disclosed embodiments, location, size, and orientation of scene elements, for example, are determined by a constraint satisfaction algorithm.

Composite scenes may be stored in a single database. Alternatively, composite scene elements may be are stored in separate databases, such as on different computer systems at separate locations.

Certain embodiments of the composite scene also might be three dimensional scenes, and the three dimensional scene may be animated. Moreover, the composite scene passcode may include more than 3 dimensions. Additional dimensionality may be provided by considering viewpoints, lighting, and combinations thereof. As another example, the passcode may include a time element.

Another disclosed embodiment concerns a method for using a composite scene passcode comprising generating a composite scene passcode, and using the passcode to obtain access to a passcode-protected system. Generating a composite scene passcode may include a presentation period selected to allow sufficient exposure of the composite scene to allow the user to submit the passcode to long term memory. The presentation period may be from about a few milliseconds to at least several minutes. The passcode may be presented to the user multiple times. Furthermore, presentation of the composite scene passcode may be accompanied by other techniques designed to facilitate passcode retention. For example, presentation of the composite scene may be accompanied by a verbal description of the important image elements that need to be remembered, the composite scene may be accompanied by a serial presentation of scene elements that need to be remembered, or as yet another alternative, presentation of the composite scene may be accompanied by non-visual information to increase memorability.

Still another embodiment of the present invention comprises generating an alphanumeric password. The alphanumeric password is presented either synchronously or sequentially with the composite scene. In certain embodiments, each image element or combinations of image elements from one or multiple scene dimensions correspond to one character in the alphanumeric password.

The method may comprise presenting a request to the user for authentication. The user then enters a user-identification, and a computer system presents a graphical password challenge. For example, a computer may iteratively move through all n* scene dimensions of the passcode presenting image elements and the user selects image elements that form a concatenated composite scene passcode. The concatenated passcode may be checked against a stored passcode. If the user forgets the alphanumeric password, a composite scene passcode generation process can be used to regenerate all or some portion of the alphanumeric password. The user can complete the alphanumeric password at any time during the composite scene generation process, without further presentation of scene elements or scene dimensions.

Still another embodiment of the disclosed method comprises first allowing the system or a user to generate a graphical passcode. The system or user also generates an alphanumeric password. The user can then be required to enter both the graphical passcode and the alphanumeric password to gain access to the system. If the user selects both the graphical passcode and the alphanumeric passcode, the system can create a mapping between the passcode and the password, and store the mapping in a database. For this embodiment, the passcode may be based on a tiled set of images, may be a locimetric passcode, a graphical passcode, or a composite scene passcode. The system may be, for example, a computer system, automatic teller machine, business access control, telephone, cell phone, other handheld electronic device (such as a Palm Pilot), a network, or an interne-based service or system.

In another embodiment, a method for screening access to a system comprises of generating a graphical passcode comprising plural image elements, where authentication is done by presenting a plurality of image elements in at least one categorical authentication grid to a user. The user can then select the image elements from the categorical authentication grid(s) that form the graphical passcode, and the selected image elements can be compared with a stored graphical passcode to determine whether to grant access to the user.

In any of the above embodiments, the alphanumeric password and/or the composite scene passcode and/or the graphical passcode can be encrypted

A computer program stored on a computer readable medium for protecting user access to a computer using a passcode also is disclosed. The program can include a code segment that displays a composite image to a user comprising a plurality of scene dimensions. The program also can include a code segment that requires the user to select scene dimensions included in the composite image. Another code segment can compare a passcode entered by the user with a stored passcode. Another code segment can permit user access to the computer when the entered passcode is identical to or substantially identical to the stored passcode. A code segment can also encrypt user input information, one or more alphanumeric passwords, and/or one or more graphical passcodes.

A system using a composite scene passcode also is disclosed. One embodiment of the system comprises a display for displaying a composite scene passcode or plural scene dimensions for generating the composite scene passcode, and an input device used by a user to input image selection useful for compositing a composite scene passcode and to enter the selections into memory and for reentering the passcode to obtain access to the system.

Disclosed embodiments substantially increase the ability of users to remember passcodes. While not being bound to a theory of operation, this goal is achieved in three ways. First, meaningful visual information is more easily remembered than textual material or meaningless visual material. Focusing on abstract visual material or unknown faces thus fails to take full advantage of the superior memorability of pictorial information. Isolated presentation of pictorial material might also negate one of the main benefits of picture memory—the interaction of multiple objects in a scene. Composite scene authentication attempts to maximize the meaning or gist of the presented pictorial information to optimize memory performance. Second, graphical passwords can use recognition memory for pictorial elements rather than the free recall required for alphanumerical passwords. In addition, there is no need for the user to remember sequential information (as in textual, spatial, or locimetric passcodes that require the user to indicate a particular sequence of locations within a picture). Third, categorically organized authentication screens enable the user to more quickly and correctly recognize the target scene elements that are part of their passcode. The use of distinctive and dissimilar scene dimensions can optimize the visual search for the target elements within a homogenous authentication screen that only includes elements from one scene dimension. Other approaches rely on selection screens that do not adhere to such a categorically organized structure, which leads to inferior performance.

The foregoing and other objects, features, and advantages of the invention will become more apparent from the following detailed description, which proceeds with reference to the accompanying figures.

### BRIEF DESCRIPTION OF THE DRAWINGS

FIG. 1 is a composite scene presented during encoding comprising various scene elements, such as background, male, object, pet, other animal, female, the female's pose elements, child, and the child's pose elements.

FIG. 2 is an image illustrating scene element and distracters.

FIG. 3 is an image illustrating female scene element and distracters.

FIG. 4 is a female pose element having the correct pose for the female in FIGS. 1, and 15 distracter poses.

FIG. 5 is a graph of percentages of passcodes remembered versus time.

FIG. 6 is a schematic drawing of one embodiment of a computer system useful for implementing embodiments of the disclosed technology.

FIG. 7 illustrates a composite scene, and the nine individual elements that are used to create the composite scene.

FIG. 8 illustrates a categorical authentication grid, where a user must choose the correct element appearing in the composite scene passcode from among distracter elements belonging to the same category (e.g. adult males).

FIG. 9 illustrates a sample tiled graphical passcode and corresponding authentication grid which is not organized by category.

FIG. 10 illustrates a sample passcode using sequential spatial locations within the image.

FIG. 11 is a graph comparing successful logins across different passcode types after varying amounts of time from initial presentation.

FIG. 12 is a graph comparing successful logins across different passcode types and with different complexities.

FIG. 13 is a sample composite scene comprising various scene elements.

FIG. 14 is a sample composite scene comprising various scene elements.

FIG. 15 is a sample composite scene comprising various scene elements.

FIG. 16 is a sample composite scene comprising various scene elements.

FIG. 17 is a sample composite scene comprising various scene elements.

FIG. 18 is a sample composite scene comprising various scene elements.

FIG. 19 is a sample composite scene comprising various scene elements.

FIG. 20 is a sample composite scene comprising various scene elements.

FIG. 21 is a sample composite scene comprising various scene elements.

FIG. 22 is a sample composite scene comprising various scene elements.

### DETAILED DESCRIPTION

### I. Terms and Introduction

The following definitions are provided to assist the reader in reviewing the present disclosure. The definitions should not be construed to provide a definition narrower than would be understood by a person of ordinary skill in the art.

Unless otherwise noted, technical terms are used according to conventional usage. As used herein, the singular terms “a,” “an,” and “the” include plural referents unless context clearly indicates otherwise. Similarly, the word “or” is intended to include “and” unless the context clearly indicates otherwise. Also, as used herein, the term “comprises” means “includes.” Hence “comprising A or B” means including A, B, or A and B. Although methods and materials similar or equivalent to those described herein can be used in the practice or testing of the present disclosure, suitable methods and materials are described below. In case of conflict, the present specification, including explanations of terms, will control. In addition, the materials, methods, and examples are illustrative only and not intended to be limiting.

Authentication refers to the time a userID and a passcode need to be presented by a user to gain access to a protected entity, such as a particular file on a computer, access to a particular program, access to a physical location, access to a system, network, web site, or application etc. Authentication can be used to control access to any file, feature, element, or functionality of a system.

Categorical authentication grid refers to the selection screen during authentication from which the user has to choose one target scene element that is part of their passcode among one or more distracter elements that are not part of their passcode. An authentication grid usually contains exactly one correct element and a larger number of incorrect (distracter) elements but multi-page authentication grids with only one correct choice for multiple pages are also possible. In these cases, some of the pages might not contain any correct choice. The authentication grids are typically organized categorically along the scene dimensions that were used to generate the graphical passcode. This enables the user to search for a particular scene element within this category more easily than having to search for an unpredictable scene element among a heterogeneous set of distracters.

Character(s) refer(s) to elements of a symbolic alphabet. The most commonly used alphabet with current computers consists of uppercase and lowercase letters, digits, common symbols, and, depending on the font used, abstract symbols or icons. Even though we use the term character(s) and alphanumeric password throughout the application, we assume that a person of ordinary skill in the art will appreciate that the use of the term character(s) and alphanumeric does not preclude other symbolic systems in which a, finite set of symbols constitutes the alphabet and a character is an element of this alphabet.

Composite Scene refers to a scene or image, e.g. a reproduction, such as an optically formed duplicate, counterpart or other presentation of an object that is composed of one or plural scene dimensions.

Constraint Satisfaction Algorithm refers to the process of finding a solution to a set of constraints. The constraints consist of the allowable values for variables. A solution is an evaluation of these variables that satisfies all constraints. The techniques used in constraint satisfaction depend on the kind of constraints being considered. Often used are constraints on a finite domain, in our case the number of scene dimensions and a set of attributes of a scene element for that scene dimension. Such problems are usually solved via search, in particular a form of backtracking or local search, but other approaches are also viable.

The constraint satisfaction algorithm is useful for determining a sufficient state of variables given a discrete domain and set of constraints. For the present invention, the scene dimensions and a set of attributes for each scene element are the set of variables, the values of which represent the domain, and the constraints are rules that are helpful in maximizing the suggested narrative of a composite scene. For example, given all of the space between the ground and the sky in an image of a beach, the algorithm can take into consideration that a particular scene element requires as part of its attributes that it needs to be situated on a solid surface. The algorithm would thus place the element only in a position that is not covered by air or water. Additionally, this algorithm can take interactions between elements into account, such as correctly positioning people to play baseball, etc.

Distracter refers to, for example, a variable presented to a user that may be selected, but which is not part of a passcode. Solely by way of example, a distracter may be a scene element that was a possible selection during passcode enrollment, but was not selected by the user or system for passcode generation for this scene dimension. Thus, a user may be presented with a set of scene elements during authentication and asked to select the correct target scene element, but the user is free to select a distracter instead. Since the distracter is an invalid entry for the passcode, the user would be generally precluded entry to the system.

Enrollment refers to the time when a user, a system administrator or the system itself has requested the creation of a passcode and the passcode is being generated using the constraints of the particular system. A link also typically is made at this time between a user's identification and the passcode being generated.

Passcode is a general term referring to something that has the same purpose as a password, but which does not use characters, such as letters, numerals and/or symbols, as the sole basis for generating, presenting, or entering the passcode, and in this context most typically refers to a composite scene that is used to gain access to a system.

Password typically refers to the traditional password authentication currently employed by computer systems. It is usually a word, phrase and/or numbers that must be used to gain access to a desired system, and even more particularly refers to a sequence of characters, such as letters, numbers and/or symbols that are inputted to a computer system to gain access thereto.

Scene Dimension can be considered as a variable that is part of a composite scene, but which can change in value. For example, a particular scene dimension might be the identity of the male figure in the scene, and the different values would consist of different male persons that could potentially be depicted in the scene. Examples of scene dimensions include, but are not limited to, humans, inanimate objects, animate objects, flora, geological images, backgrounds, and artistic and abstract scene elements. Each of the scene dimensions include plural species thereof, all of which are within the scope of the present invention. Again by way of example, and without limitation, humans can include at least the following scene dimensions: humans of various ages, such as, children, adults, and the elderly; different genders; and different ethnicities. Humans also can be depicted in different manner, such as by considering various poses, various physical characteristics, such as height and weight, performing various activities, engaged in various professions, etc. Inanimate objects can include items such as automobiles, bicycles, fences, sidewalks, streets, musical instruments, phones, vases, sports equipment, etc. Animate typically refers to living things capable of movement, other than humans, such as animals generally, and more specifically types of animals, such as pets, birds, wild mammals, fish, etc. Scene dimensions that may be classified as flora include trees, flowers, shrubs, grasses, etc. Geological image scene dimensions include mountains, rivers, oceans, canyons, rock formations, etc. Backgrounds include such things as architectural spaces, e.g. buildings, cities, streets, parks, plazas, etc., other, outside environments, such as forests, beaches, sky, the arctic, oceans, etc., events, such as parades, athletic events, demonstrations, etc., and even extraterrestrial spaces, such as other planets, moons, suns, galaxies, meteors, etc. Scene dimensions can also include artistic elements, such as paintings, pictures, abstract art, fractal or otherwise mathematically generated visual objects, etc.

A scene dimension can be defined by the actions of one or the interaction between two or more scene elements, e.g., the spatial relations between objects, actions associated with an object, interactive exchanges, etc. In addition, scene dimensions can consist of changes in viewpoint, lighting, and other two dimensional or three dimensional scene parameters. Finally, scene elements may change over time, adding temporal scene dimensions, such as animation, to the composite scene.

For authentication, variable numbers of elements of each scene dimension may be presented. For example, and with reference to humans as the scene dimension, a user might be presented with 16 different male images during authentication. Only one of which was part of the composite scene. Likewise, a variable number of female images might be presented, such as 16 different females. Depending on the number of possible selections from a particular scene dimension, a single screen might be presented to display all possible choices to a user, particularly if the possible selections are relatively few, such as 16 or fewer. However, for more secure passcodes, larger numbers of possible selections may be presented for each scene dimension. Again referring to male human as a scene dimension, if the number of possible selections is substantially greater than may be presented on a single display, then plural such displays may be provided to the user to perform the selection. A scene dimension may correspond to a particular location in the composite scene.

A person of ordinary skill in the art will appreciate that the number of possible scene dimensions a particular system might use is potentially infinite, and further that while the general approach disclosed herein uses particular scene dimensions to illustrate the concept, the scope of the invention is not limited to such scene dimensions. Moreover, a particular entity utilizing composite scene passcodes may want to select scene dimensions particular to that entity or of particular relevance for the intended user group. For example, a sports equipment company may want to present images corresponding to particular products in its product line, as such products presumably would be readily recognized by the entities employees and customers.

As another example, the scene dimensions may be selected so as to facilitate the ability of a user to recall the scene dimensions and hence the passcode. In this case, a particular selection of scene dimensions might make it easier for users to employ recognition memory to remember the correct passcode. So, in one sense, the scene dimensions may be completely arbitrary, but also may have some association for the individual user that facilitates retention and hence recognize or recall. Also, each scene dimension selected by an administrator for generating passcodes might be as distinct from one another as possible to also facilitate retention and recognition or recall. This also applies to the elements available for each scene dimension—to increase memorability the different elements would preferably be very different from each other. In general, the scene dimensions will be, but need not be, categorically organized. Categorical organization will enable the system to use categorical authentication grids, which improve recognition performance.

Scene element refers to any item visually perceptible, such as an image, or at least a portion thereof, that can be displayed to a user, such as on a display or on any other suitable medium, such as paper. The phrases “scene element” and “image element” are used interchangeably.

System refers to a working combination of hardware, software, and/or data communications devices. A system may be, for example, a computer system, automatic teller machine, business access control, telephone, cell phone, other handheld electronic devices (such as a Palm Pilot), a network, or an internet-based service or system. A system can refer to a single computer or device, or to a network of plural computers or devices. A system can include an internet-based system, such as a web site.

Two-dimensional scene refers to a scene that is composed out of two dimensional scene elements. Even though the scene may contain depth cues to induce the impression of depth in the image, for example through common pictorial depth cues (interposition, texture gradients, size, etc.) it can easily be assembled from two dimensional scene elements by positioning them at x,y coordinates within the image plane.

Three-dimensional scene refers to a scene that is composed out of three dimensional scene elements. The creation of a three dimensional scene assumes a three-dimensional space wherein three dimensional models of scene elements can be placed at x,y,z coordinates and in different orientations. A three dimensional scene enables different “camera” positions or viewpoints from which the scene can be rendered and thus allows more flexibility than a two dimensional scene to coordinate scene elements and viewpoints. In addition, different lightning models and rendering techniques can be employed to produce a two dimensional image representing a particular view of the three dimensional scene. As a shorthand, we sometimes also refer to the two dimensional image representation of a three dimensional scene as a three dimensional scene.

### II. Enrollment

### A. Password Generation or Selection

The enrollment phase of the present process can be implemented in several different embodiments. The enrollment phase usually consists of a request to generate a new passcode for a particular userID, the generation of a composite scene based on the generated passcode, and the presentation of the new composite scene to the user for memorization. Unlike any other approach to graphical authentication systems, we envision that graphical passcodes can be used either in isolation, as the only means of authentication, or in conjunction with other forms of passcodes, such as, but not limited to, traditional alphanumeric passwords. Graphical passcodes can thus supplement already existing authentication schemes and serve as a way to redundantly code the relevant information.

Exemplary embodiments of the present invention are disclosed below. A person of ordinary skill in the art will appreciate that the scope of the invention is not limited to these exemplary embodiments.

1. Randomly Assigned Graphical Passcode

During the enrollment phase, a user of a system may need to generate a new passcode. The system thus receives a request from the user, a system administrator, or the system itself to generate the new passcode. The request may specify the dimensionality n of the passcode space, e.g., the number of independent scene dimensions to be used to generate the passcode. The dimensionality n can be set by a user, system administrator, or system itself to provide the desired security level. The passcode consists of a subset of n* passcode scene dimensions that results in a total complexity of C*=k₁×k₂× . . . ×kₙ, with kᵢ being the number of elements for scene dimension i (set size). The user, the system administrator, or the system itself can set the set-sizes for each passcode scene dimension, which may vary between 2 and kₘₐₓ. The request may be specific to a particular user identification (userID). A computer system then generates a passcode consisting of n* elements from sets k₁ to kₙ, by randomly selecting an element from each of the scene dimensions. The passcode may be generated in the form of a sequence of scene elements, a tiled set of scene elements, and/or a composite image containing the scene elements. After the passcode is generated, the system will save a link between userID and passcode for future authentication purposes.

The random assignment of a passcode by the system is a currently preferred method for implementing the composite scene authentication system because it provides the strongest passcodes and is most secure. However, a particular system might allow users to choose their own composite scene elements. In this case, security would be lowered, but the user might remember the passcode even better than a randomly selected one (see embodiment 2 below).

2. User Selected Graphical Passcode

Again, a system receives a request from a user, system administrator, or the system itself to generate a new passcode. A computer system allows a user to select passcode elements out of n* passcode scene dimensions so that the user can design their own passcode. As with the randomly assigned passcode embodiment, the number of passcode scene dimensions can vary to establish a desired security level. Each scene dimension is associated with a set of visual elements of size kᵢ. Set size can vary across scene dimensions. Depending on how a particular system is implemented, the user would see one or more sets of potential scene elements for each scene dimension and would have to choose one of them (e.g., through a pointing device or any other type of input device entry, such as by voice command or keyboard entry). The passcode may be generated in the form of a sequence of scene elements, a tiled set of scene elements, and/or a composite image containing the scene elements. The generated passcode can then be presented to the user and may be stored with the userID. After the passcode is generated, the system will save a link between userID and passcode for future authentication purposes.

3. Randomly Assigned Alphanumerical Password with Redundant Graphical Passcode

Just as randomly assigned passcode embodiment, the system receives a request from the user, a system administrator, or the system itself to generate a new password. The request may specify the dimensionality n of the password space and the complexity or set size at each password position. Just as in a traditional password system, a random string of n characters (symbols, letters, digits, etc.) forms the new password. Each of the characters in the string represents a choice out of the set of all possible characters at the particular position within the string (e.g., first element, second element, etc.). The set of characters for each position is usually identical, but can vary across positions. For example, the first character of the password string could be constrained to only include uppercase letters, thus reducing the number of possible selections from approximately 100 for a traditional alphanumeric password to 26.

The new password can easily be translated into a graphical passcode by mapping the alphanumeric elements in the password to corresponding scene elements in a sufficiently complex passcode. For example, each element (position) of the password string can be linked to a unique scene dimension in the scene authentication system. For example, the first element of a password might be linked to the scene dimension “male” in the scene, the second element to the scene dimension “female” in the scene, etc. Each of the scene dimensions is constructed to have an identical or larger set size of scene elements as the set of characters that is allowed at that position in the password. This way, each character of the password can be unambiguously identified by one (or more) scene elements in the composite scene. The only requirement is that each character is associated with at least one scene element, and that each scene element is at most associated with one character of the password. As long as each scene element is only linked to one character in the alphanumeric passcode, the alphanumeric character is thus retrievable by selecting the correct scene element.

If it is infeasible to map an element (e.g., the first character) of the alphanumeric password to a single scene dimension (because e.g., the scene dimension does not contain as many scene elements as are necessary to uniquely identify all possible characters in this position of the password) then more than one scene dimension could be used to represent the character. If, for example, the alphanumeric character space at the first position of the password is 100 elements, then two scene dimensions of set size 10 could combine to uniquely identify each possible character. To gain efficiency, pairs or triplets of characters might be linked to a subset of scene dimensions. In general, the only requirement of redundant coding is that the total complexity of the graphical passcode space is larger or identical to the complexity of the alphanumeric password space to uniquely map a graphical passcode to an alphanumeric password.

The random assignment of a password and the resulting graphical passcode by the system is a currently preferred method for implementing this supplemental use of the composite scene authentication system in conjunction with traditional passwords because it is most secure. However, a particular system might want to let users choose their own composite scene elements. In this case, security would be lowered, but the user might remember the password better than a randomly selected one.

The generated password and resulting graphical passcode then may be stored with the userID for future authentication purposes.

4. Redundant Graphical Passcode for User Selected Alphanumerical Password

Again, a system receives a request from a user, system administrator, or the system itself to generate a new passcode. As with the other embodiments, the number of passcode scene dimensions and the number of scene elements within each scene dimension can vary to establish a desired security level. However, unlike the previous embodiments, the user is asked to select a traditional (e.g., alphanumerical) password, which, in turn, determines the graphical passcode. In this case, just as in the randomly assigned alphanumerical password with redundant graphical passcode embodiment, the alphanumeric password is mapped onto the graphical passcode space in such a way that the graphical passcode uniquely identifies the alphanumeric password. Again, the only formal requirement for this mapping consists of sufficient complexity of the graphical passcode space to encode all possible alphanumeric passwords that a user might produce. To assure this, the selection of passwords by the users might be constrained in terms of length or the characters or elements used. In a preferred embodiment, each passcode scene dimension is associated with the set of appropriate elements of the corresponding alphabet of the password (e.g., characters, letters, numbers, symbols, etc.) for one particular position within the password. Depending on how a particular system is implemented, this process step could involve selecting a traditional alphanumeric password (having, for example, up to 100 elements per scene dimension, including lower- and upper-case letters, digits, symbols, etc.), a hexadecimal password (16 elements per scene dimension), or any other textual or related password via any type of input device entry, such as by keyboard entry or pointing. The generated password and the resulting graphical passcode then may be stored with the userID.

5. Redundant User Selected Graphical Passcode and User Selected Alphanumerical Password

Just as in the two previous scenarios above, redundancy between graphical passcodes and alphanumeric passwords can also be applied to situations in which the user selects both freely. Upon receiving a request from a user, system administrator, or the system itself, the system allows the user to select an alphanumeric password of a specific length and a graphical passcode as described above (User Selected Graphical Passcode). In this case, however, the system restricts the alphanumeric password length and complexity to assure that the graphical passcode space is as complex as, or more complex than, the alphanumeric password space (as described under Redundant Graphical Passcode for User Selected Alphanumerical Password).

Once this requirement is met, any chosen alphanumeric password can be uniquely identified by a chosen graphical passcode. Once both the password and passcode are chosen, the system needs to store both codes as well as an adequate mapping function from the graphical passcode space to the alphanumeric password space together with the userID. This will allow the user to retrieve the alphanumeric password by entering the graphical passcode. In an ideal situation, the mapping between the two passcode/password spaces is isomorphic for each scene dimension or position within the alphanumeric password. In this case, each scene element is uniquely linked to one particular character within the password, and each character within a password is uniquely linked to a particular scene element in the graphical passcode. However, such mapping need not be isomorphic. For example, if the number of available characters is greater than the number of scene elements for a particular dimension, the mapping can map more than one scene element to a particular character or group of characters. A prototype of such a system has been developed.

Of course the mapping does not have to be from one particular scene dimension to a particular character or position within the alphanumeric password. Instead, as described in detail in Randomly Assigned Alphanumerical Password with Redundant Graphical Passcode, subsets of scene dimensions might be used to uniquely map onto subsets of characters in the alphanumerical passwords.

### B. Generation of Composite Scene

1. Generating a 2-dimensional Composite Scene Based on the created passcode, the computer assembles the scene elements to generate a composite scene. Each scene dimension corresponds to a set of predefined scene elements that are stored in a database or databases accessible to a networked system. These scene elements can be any of a variety of elements, as will be appreciated by a person of ordinary skill in the art. Solely by way of example, and with reference to a working embodiment, the scene elements are ordered based on categories. For example, the scene elements for working embodiments included: background, male person, female person, child, pet, wild animal, inanimate object. In addition, scene dimensions can be conditionally related to other scene dimensions as modifiers. For example, “pose of the female person” might be a scene dimension that is conditionally related to another scene dimension as a modifier, showing the same female person in a plurality of different poses, sometimes accompanied by additional objects and differences in clothing. In general, the scene dimensions will be (but need not be) categorically organized. Categorical organization will enable the system to use categorical authentication grids, which improve recognition performance.

In one approach, individual scene elements are placed into the composite scene at predefined x,y-image coordinates as each scene dimension might be assigned particular x,y-coordinates at which to place the images. As an alternative embodiment, dependencies between scene elements and constraints about the placements of images may be stored in a database. In another alternative embodiment, dependencies and constraints can be inferred or determined by the system or an algorithm. Certain physical parameters concerning image generation, such as the location and orientation of the scene element and additional scene relevant features, such as monocular depth cues, i.e., relative size of an object, its height in the picture plane, interposition, aerial perspective, texture gradients, etc., may be stored with the scene elements to increase the interactivity among the elements. Exact location, size, and orientation of scene elements, can then be determined by a constraint satisfaction algorithm. The algorithm determines how best to relate the scene elements to another. For example, the constraint satisfaction algorithm may determine the exact positions of the male and female elements for a particular interaction, taking their poses into account. Similarly, different scene backgrounds might require the positioning of scene elements in specific areas of the scene. Alternatively, the entire set of composite scenes also could be available in a single database. Alternatively, composite scenes could be stored in different databases, or on different computer systems at separate locations.

2. Generating a 3-dimensional Composite Scene

Instead of relying on the 2-dimensional placement of scene elements at predefined x,y-coordinates within a composite scene, composite scene generation also can be achieved by placing 3-dimensional scene elements into a 3-dimensional scene and rendering the scene for the final composite image. In this case, the 3-dimensional elements can be enriched by adding information about possible interdependencies between elements to achieve the impression of an increased interactivity between the elements relative to 2-dimensional composite scenes.

In a working embodiment, for example, a composite 3 dimensional scene may contain a male and a female figure. Both figures are stored as 3 dimensional models in a database. For each model, different positions, facial expressions, clothing, movements, actions, and other identifiable features, are available through the database or through associated programming of the individual models. The underlying passcode of the scene composite requires both figures to interact by playing catch. The system places both models in the appropriate locations, facing towards each other. The male model is in a “throwing” position, whereas the female model assumes a “catching” position. A ball is placed along a plausible trajectory between the two. Similarly scripted scenes are being employed in 3 dimensional computer animation and could be used to generate desired composite scenes given a particular passcode on the fly. Rendering of the scene would then create a seamless composite scene that included the elements in an interactive organization from one particular point of view. In addition to the scene dimensions mentioned above, additional scene dimensions for 3-dimensional scenes are the viewpoint chosen for the rendered image, lighting parameters, environmental parameters (e.g. fog), etc.

3. Additional Scene Dimensions

A person of ordinary skill in the art will appreciate that composite scene passcodes might be presented in more than 3 dimensions. As a first example of this approach, a time element can be introduced into the passcode. Again with reference to humans as a scene dimension, such humans might be displayed as performing a particular task, such as walking, jogging, etc. This approach therefore introduces a temporal dimension. As another example, a particular composite scene might be presented in different orientations, or from some different perspective.

### C. Presentation During Enrollment

The image generation process generates a composite scene. This composite scene is then presented to a user during enrollment for a limited time referred to herein as the presentation period. The presentation period can vary as may be desired, but such period is selected to allow sufficient exposure of the composite scene to the user so that the user can glean sufficient information to submit the passcode to long term memory, thereby allowing passcode retention by the user. For example, the presentation period is from about a few milliseconds to at least several minutes, hours, or even days, typically from a few 100 milliseconds to at least two minutes, and even more typically from about one second to about ninety seconds. It will be understood that, if the presentation time is longer than a few seconds, the user need not view the displayed passcode, or elements thereof, during the entire presentation time, but rather for just so long as the user deems necessary to retain the displayed information. Furthermore, the presentation period can vary based on the complexity of the passcode, with more complex passcodes requiring longer presentation periods. And passcodes might be presented to a user multiple times.

Presentation of the composite scene can be accompanied by other techniques designed to facilitate passcode retention. In one embodiment, presentation of the composite scene may be accompanied by a verbal description of the scene elements, particularly scene elements that facilitate recall or recognition. For example, a verbal description of a name that uniquely describes the background might be uttered, as may references to all, or some desired subset thereof, of the other scene dimensions and their particular values (the particular image elements) in the scene. The verbal information, presented either auditorily or visually, may be redundant and optional for the proposed implementation but may provide important information to assist in the formation of a long-term memory of the scene. For example, a user might view a scene including the image of an eagle. The verbal description might name the bird as “EAGLE” to assure that the user's mental representation of the scene includes this level of detail and doesn't only specify the base-level category “BIRD.” In a different embodiment, there might be an additional serial presentation of the scene elements during or before or after the presentation of the composite to increase memorability. Presentation can include spatial or temporal separation of scene elements. Other additional information that can be provided in conjunction with the composite scene is non-verbal auditory information, such as sounds and music, tactile information, such as vibration, and information for other sensory modalities.

As described above, the composite scene also can be used to supplement and/or redundantly code a unique alphanumeric passcode as well. In these embodiments, the corresponding alphanumeric representation of the password can be presented in conjunction with the composite scene. Presentation of the alphanumeric passcode can be either synchronously or sequentially presented with the composite scene. In this embodiment, each scene element in each scene dimension corresponds to one character in the alphanumeric password space. This allows a user to retrieve the password during later authentication stages, either by selecting scene elements out of a set of distracters, or by recalling the corresponding alphanumeric password.

During presentation of the composite scene, the user forms a mental representation of the visual scene and the individual scene elements that make up the scene. Using objects that interact within the scene (e.g., the arrangement of the objects suggests particular actions or relations between the objects) increases the ability of the user to memorize the scene, or at least those elements necessary to recall the passcode.

In one embodiment, after the predetermined or user selected presentation duration of the composite scene, the composite scene disappears from the screen and is not presented again. The same is true of potential redundant alphanumeric passwords that are presented in conjunction with the composite scene.

### III. Authentication

### A. First Disclosed Embodiment

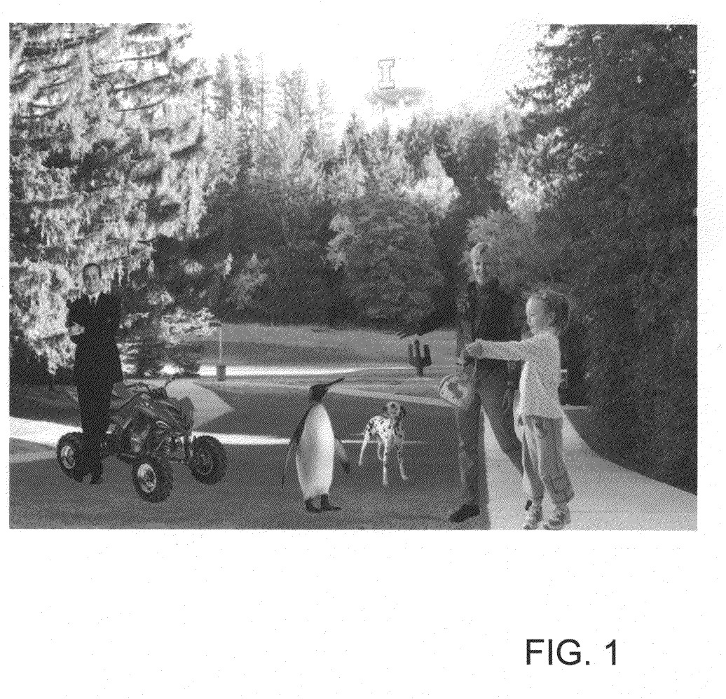

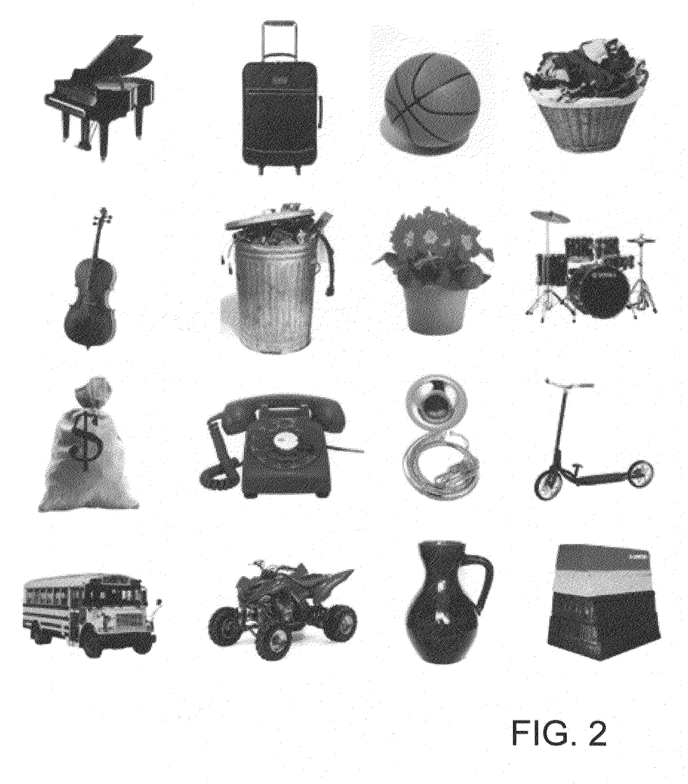

One disclosed embodiment can include authentication. For example, a request for user authentication may be presented. The user then enters his/her user-identification, and the computer system presents, a graphical passcode challenge. The computer graphically presents a set of image elements for each of the n* scene dimensions of a graphical passcode such as the one depicted in FIG. 1. For example, and with reference to FIG. 2, a set of 16 scene elements is presented. The scene elements can be organized as desired, such as in a 4×4 matrix, or in a different spatial arrangement, depending on the particular situation of each scene dimension. The user then attempts to select the correct scene element(s) that form the passcode. Once the user selects a scene element from that set of elements presented, the computer next presents a set of scene elements corresponding to the next scene dimension. The user typically must select a scene element for each scene dimension.

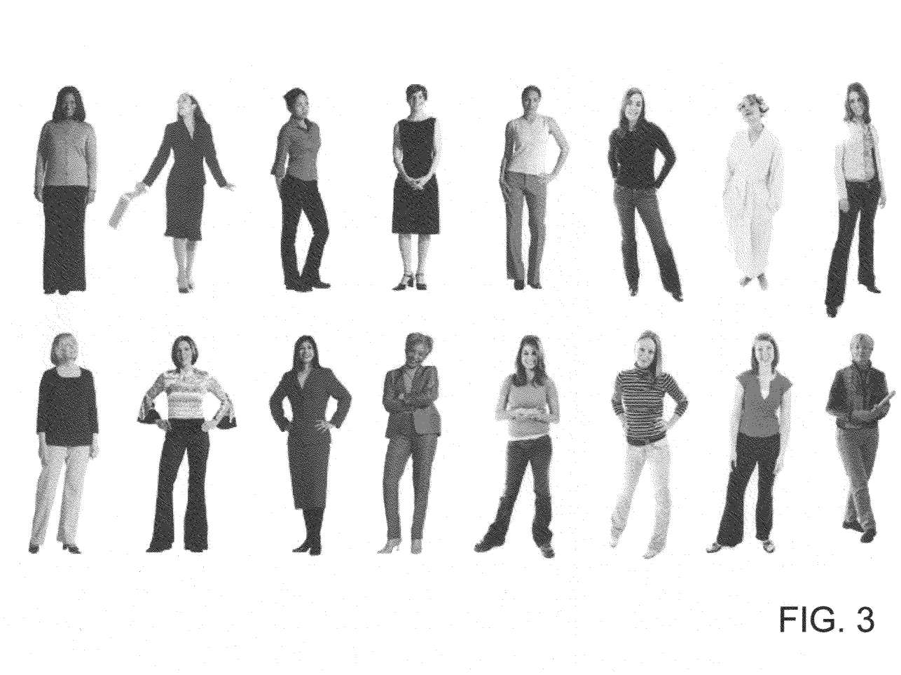

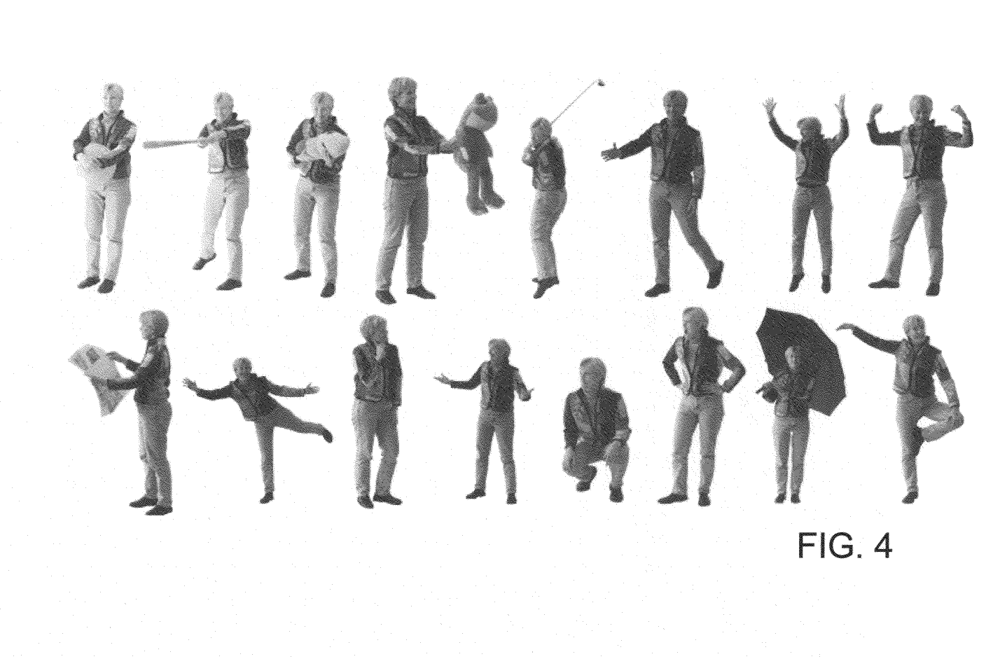

The scene element, unlike in other graphical approaches, does not have to be identical to the actual scene element presented during enrollment. In one particular embodiment, for example, the female and the child scene elements are presented in a different pose than during enrollment. For example, a user may be presented with a set of sixteen different adult females, such as seen in FIG. 3. The correct female as seen in FIG. 3 may not exactly match the body position of the female in the passcode of FIG. 1. Once a user selects the female from this first set of choices, a second selection screen prompts the user to select the correct pose for the chosen individual, such as seen in FIG. 4. FIG. 4 shows the same adult female in sixteen different poses. In this way, multiple scene dimensions can be captured within the same scene element.

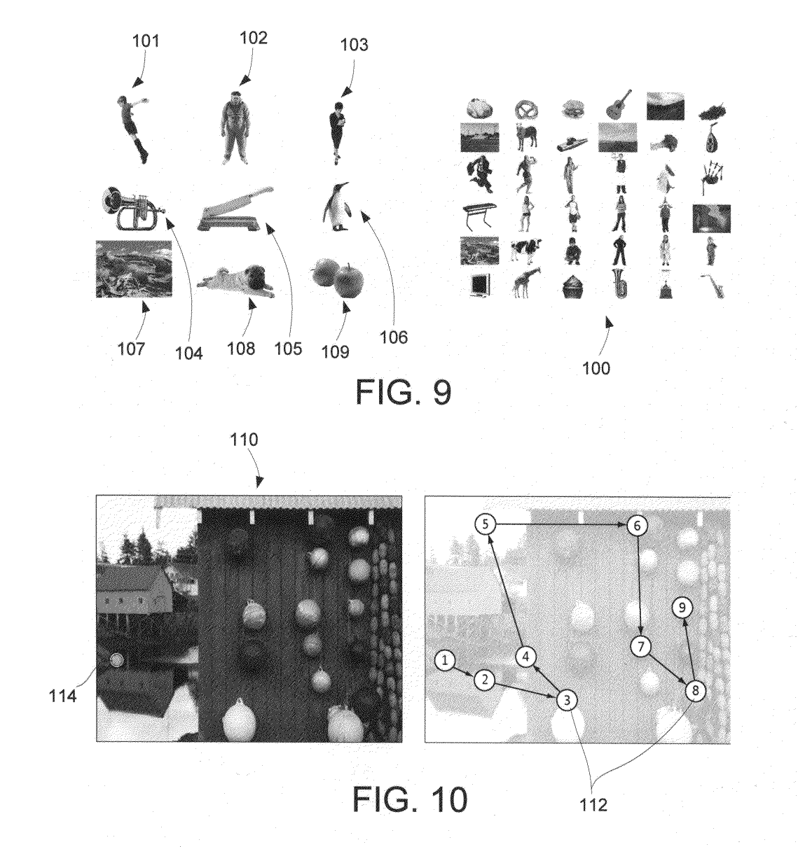

In some embodiments, a set of scene elements may include the correct scene element along with seemingly random distracters from very different categories. For example, authentication grid 100 seen in FIG. 9 contains distracters from very different categories. In this case, a user may not be able to associate all of these scene elements together categorically. This embodiment may increase the search time required for a user to locate the correct scene element. Alternatively, a set of scene elements may be categorically presented. For example, FIG. 3 depicts a set of sixteen scene elements, where all of the elements are within a single category, such as adult females. Such categorical organization of scene elements may be used for each scene dimension. For example, in authenticating the passcode scene of FIG. 1, a user may be presented with a set of distinct adult males from which he/she must choose the correct adult male; the user may then be presented with a set of sixteen distinct dogs, from which he/she must choose the correct dog from the passcode, and etc. Presentation of scene elements in such a categorical fashion can be designed specifically to aid, users in their selection process by organizing visual material into distinct categories.

The scene elements can be selected using any suitable input device, such as a pointing device (e.g. mouse, track pad, touch screen, etc.), keyboard, stylus, verbal commands, eye tracking, etc. Clicking on the image element through a pointing device is one likely implementation of this selection process. The system presents all scene dimensions and collects the selected values for each scene dimension.

After the last scene dimension is presented to the user, the concatenated passcode is checked against the stored passcode. If the iteratively generated passcode matches or exceeds the criterion of similarity with the stored passcode, access is granted. In a common implementation, the generated passcode would have to be identical to the stored passcode to be granted access. If the passcode is used in combination with another passcode(s) and/or password(s), then all or part of the other passcode(s) and/or password(s) will have to be similarly evaluated to determine the validity of the full, combined passcode.

### B. Second Disclosed Embodiment

The graphical passcode also can be used as a redundant coding of the password in case of alphanumeric passwords if both are presented to the user during enrollment. In this case the authentication request mostly can be handled through the alphanumeric password (or another form of symbolic password) as long as the user remembers the alphanumeric password. This allows for quick, standard authentication procedures and deals with a common problem of graphical authentication systems. Selecting visually presented targets out of a set of distracters can be time-consuming and inefficient compared to alphanumeric passwords that are well known and practiced. However, the advantage of graphical authentication systems becomes apparent when the password is not readily accessible. In this case, the graphical passcode serves as a simple way to retrieve the alphanumeric password by relying on recognition memory for the scene elements. If the user has forgotten all or part of the alphanumeric password the system can provide the user the option to use the graphical selection process to regenerate the alphanumeric password. In this embodiment, selecting a scene element among distracters would lead to the presentation of the corresponding alphanumeric code element, thus incrementally allowing the user to regenerate all or some portion of the alphanumeric password. At any point in time, the system could provide the user the option to complete the alphanumeric password, such as by entering the alphanumeric code (e.g., complete the password by typing in the rest). The rationale for this embodiment would be that the first few regenerated letters might trigger the memory for the whole password.

### C. Third Disclosed Embodiment

The redundant coding of traditional alphanumeric passwords does not only apply to the proposed composite scene authentication system, but to any graphical, tiled, or locimetric authentication strategy in which a link can be made between the passcode and the alphanumeric password. In general, such a system only needs to supply sufficient complexity for the generated passcode space that it is equal to or exceeds the complexity of the alphanumeric password space. Once this is guaranteed, any arbitrary mapping from the passcode space to the password space would be sufficient as long as it assigns only one password to any passcode. In theory, multiple passcodes could be mapped onto the same password to achieve this goal. In this case, the system or the user would have to select one of a plurality of passcodes that map onto the same password during enrollment. The current approach followed by the composite scene authentication system further allows for the regeneration of a particular password element because each scene dimension is linked to a particular position of the password. It is conceivable that other systems, such as a locimetric or tiled passcode system, could add this dimensionality to allow the system to regenerate alphanumeric password elements. The novel invention of linking authentication mechanisms relying on visual and spatial information to a traditional password mechanism to add redundancy and to exploit the benefits of both approaches thus generalizes beyond the composite scene authentication system described earlier.

### IV. Computer System

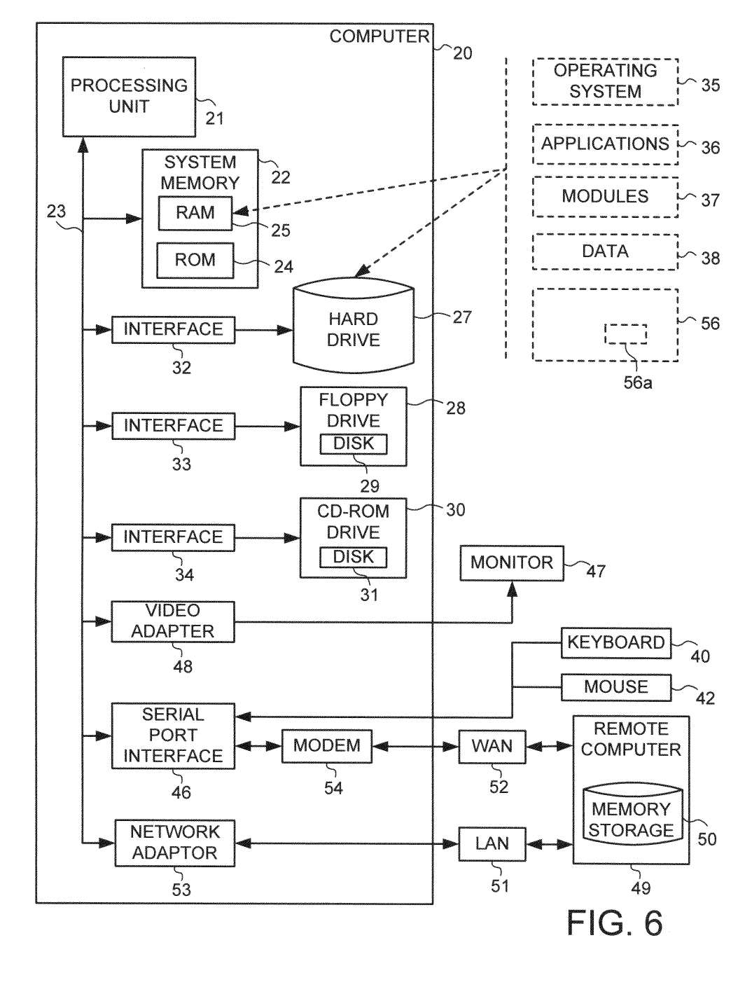

An embodiment of the invention is described with reference to FIG. 6 and the illustrated computer system. An exemplary computer system includes a computer 20 (e.g., a server computer, a personal computer or other like computer), includes a processing unit 21, a system memory 22, and a system bus 23 that couples various system components including the system memory to the processing unit 21. The processing unit may be any of various commercially available processors, including Intel x86, Pentium and compatible microprocessors from Intel and others, including Cyrix, AMD and Nexgen; Alpha from Digital; MIPS from MIPS Technology, NEC, IDT, Siemens, and others; and the PowerPC from IBM and Motorola. Dual microprocessors and other multi-processor architectures also can be used as the processing unit 21.

Any of several types of bus structures can be used including a memory bus or memory controller, a peripheral bus, and a local bus using any of a variety of conventional bus architectures such as PCI, VESA, Microchannel, ISA and EISA, to name a few. The system memory includes read only memory (ROM) 24 and random access memory (RAM) 25. A basic input/output system (BIOS), containing the basic routines that help to transfer information between elements within the computer 20, such as during start-up, is stored in ROM 24.

The computer 20 further may include a hard disk drive 27, a magnetic disk drive 28, e.g., to read from or write to a removable disk 29, and an optical disk drive 30, e.g., for reading a CD-ROM disk 31 or to read from or write to other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of data, data structures, computer-executable instructions, etc. for the computer 20. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs 36, other program modules 37, and program data 38.

A computer program may be stored on a computer readable medium, such as a CD-ROM disk 31, for protecting user access to a computer using a passcode. The program can include a code segment that displays a composite image to a user comprising a plurality of scene dimensions. The program also can include a code segment that requires the user to select scene dimensions included in the composite image. Another code segment can compare a passcode entered by the user with a stored passcode. Another code segment can permit user access to the computer when the entered passcode is identical to or substantially identical to the stored passcode. A code segment can also encrypt user input information, one or more alphanumeric passwords, and/or one or more graphical passcodes.

While the above description refers to computers, the disclosed embodiments may be suitable for use with a variety of systems. The system may be, for example, a computer system, automatic teller machine, business access control, telephone, cell phone, other handheld electronic device (such as a Palm Pilot), a network, or an internet-based service or system. Disclosed embodiments can be used by internet service provides for authenticating users trying to connect to the internet. Similarly, disclosed embodiments can be used to protect files, elements of systems, access to applications, or access to networks and/or internet-based systems and services. For example, disclosed passcodes may be used to authenticate users' access to particular web sites or account information.

### V. Examples

The following examples are provided to exemplify certain particular features of working embodiments of the present invention. A person of ordinary skill in the art will appreciate that the scope of the present invention is not limited to those particular, features exemplified by these working examples.

### A. Example 1

This example concerns one working embodiment of a process for generating a password by generating a composite image from scene elements, object element and distracters, gender elements and distracters, and pose elements. Participants (16 females, 8 males, M=20 years old) were 24 undergraduate students drawn from the University of Idaho subject pool. All participants had normal or corrected to normal vision, and participated for course credit.

All stimuli were presented to participants on 8.5×11 inch photo paper. The graphical passcode was generated by randomly selecting one of 16 visual elements for each of nine scene dimensions (background, male, object, pet, other animal, female, female pose, child, and child pose). To create an alphanumeric passcode of the same length, the same hexadecimal code was used that was used to select the image components. The hexadecimal code was presented on a sheet of photo paper in 36 point Arial font. For the authentication phases, nine response sheets (one per scene dimension) were prepared, which showed the relevant passcode element together with 15 distracters.

Participants were informed that they would be taking part in an investigation of memory, as well as an investigation of map viewing which would involve measurements of speed and accuracy. This second task was a concurrent, but unrelated, experiment that involved using a driving simulator and viewing a map. The driving simulation and map viewing task filled the time between the encoding phase and first two authentication phases of the experiment.

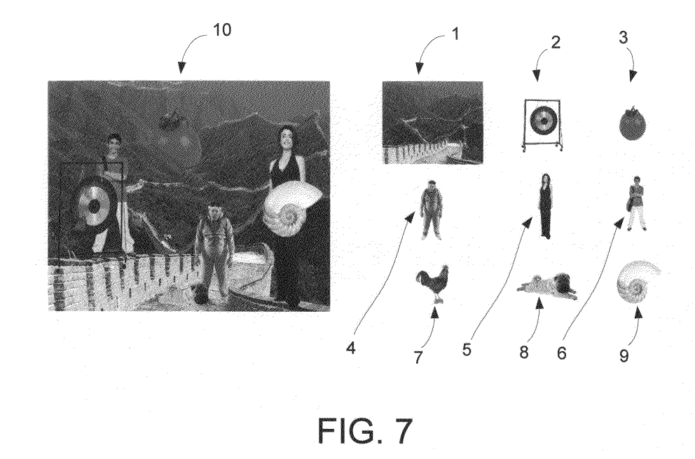

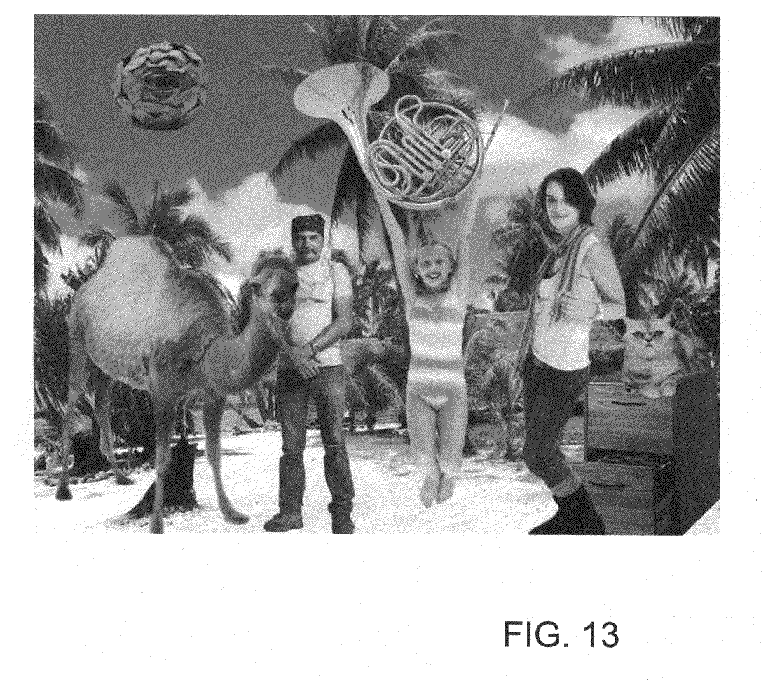

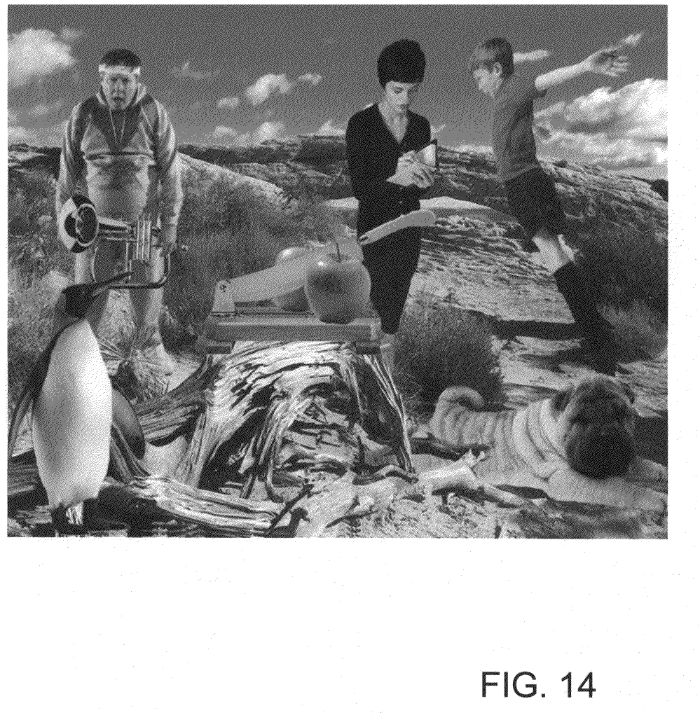

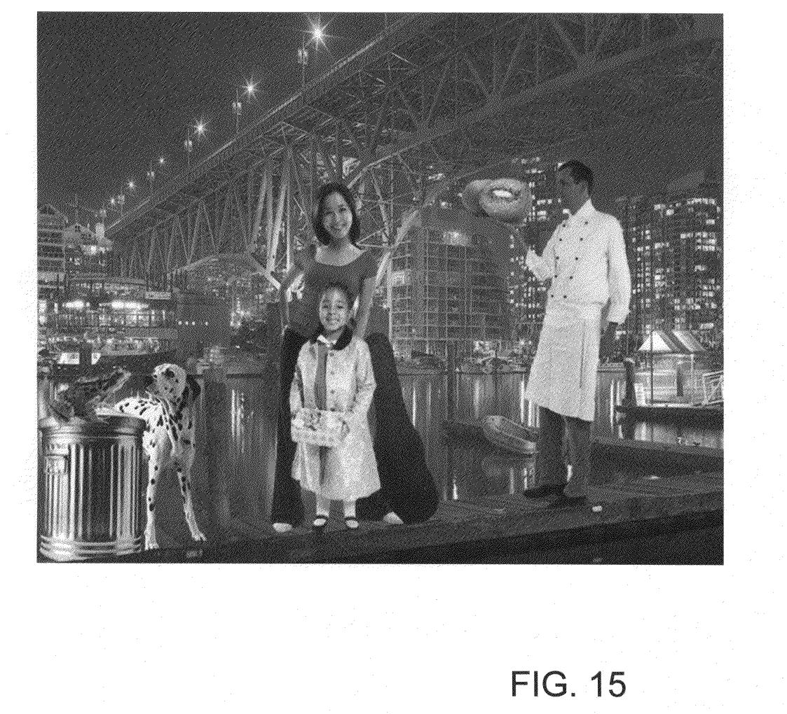

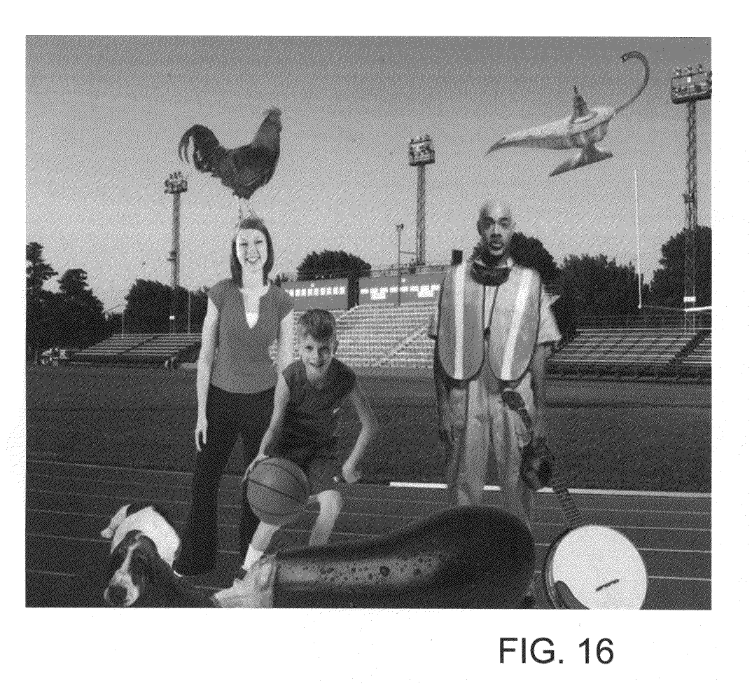

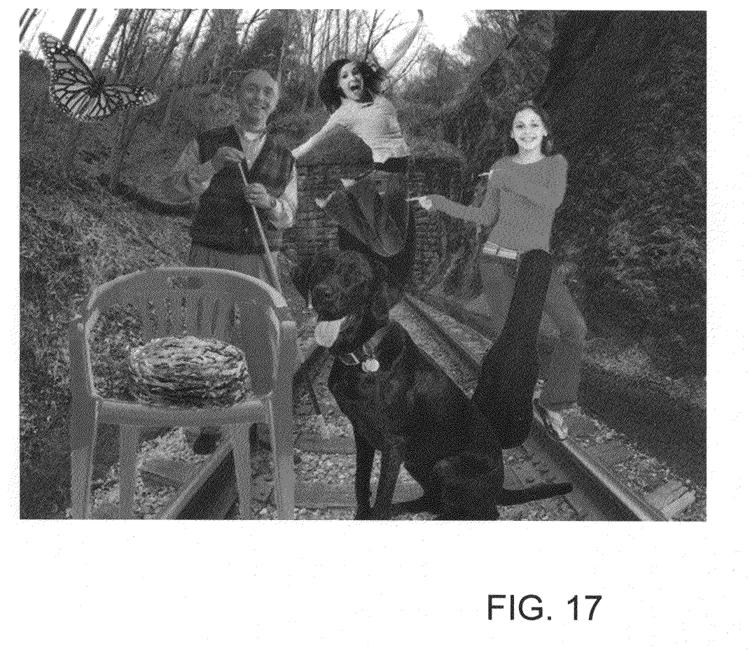

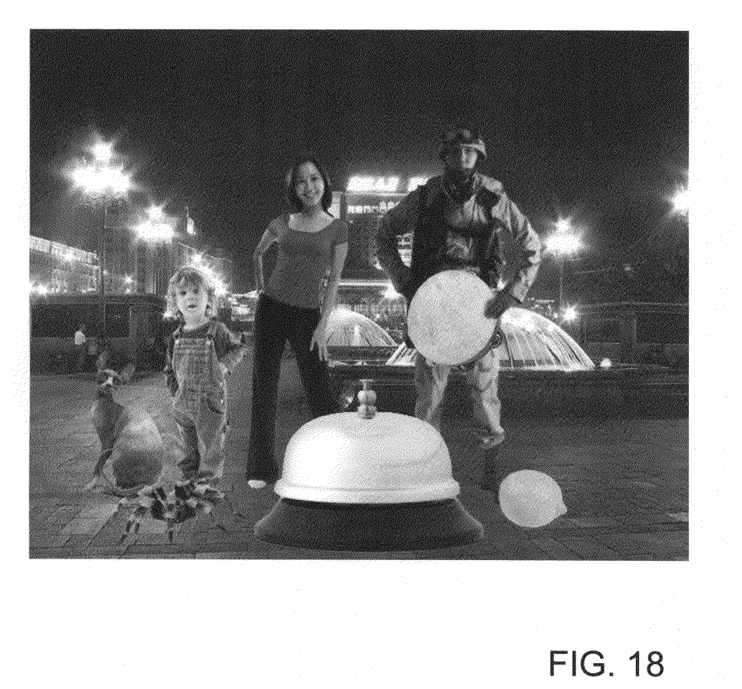

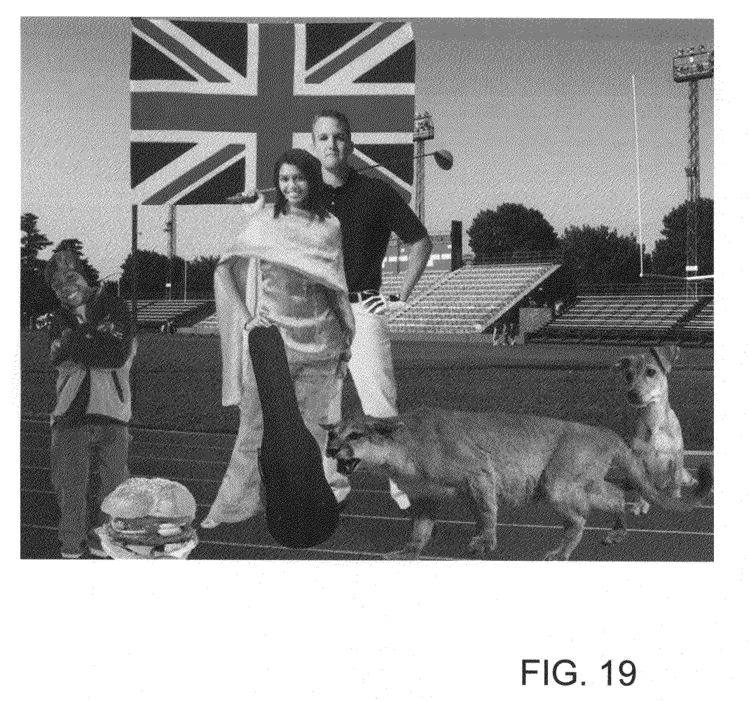

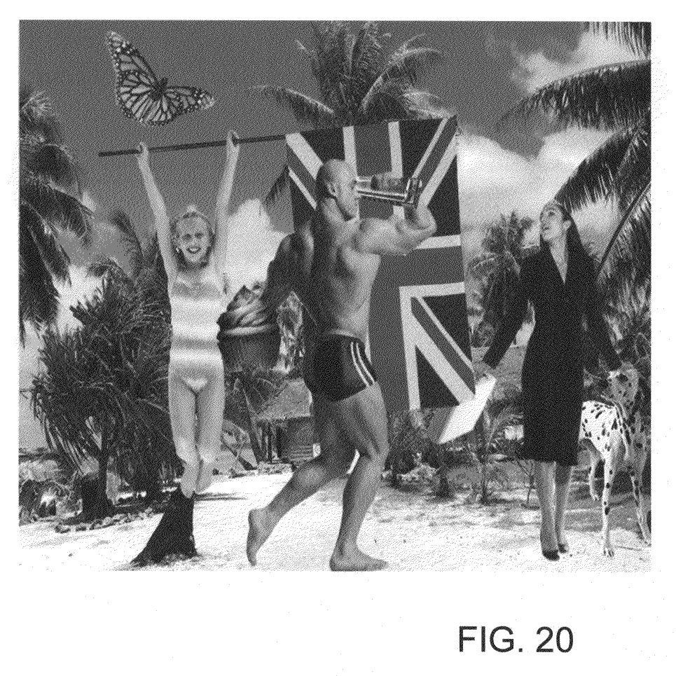

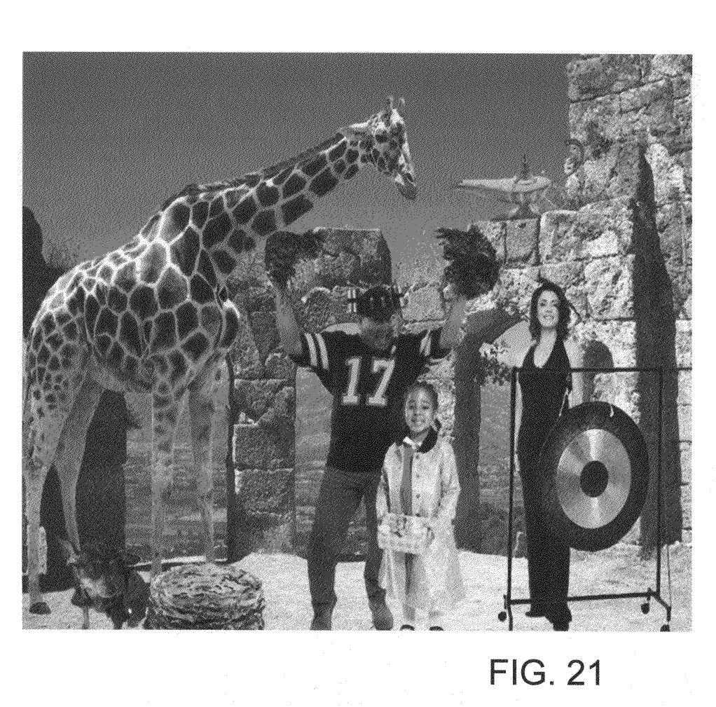

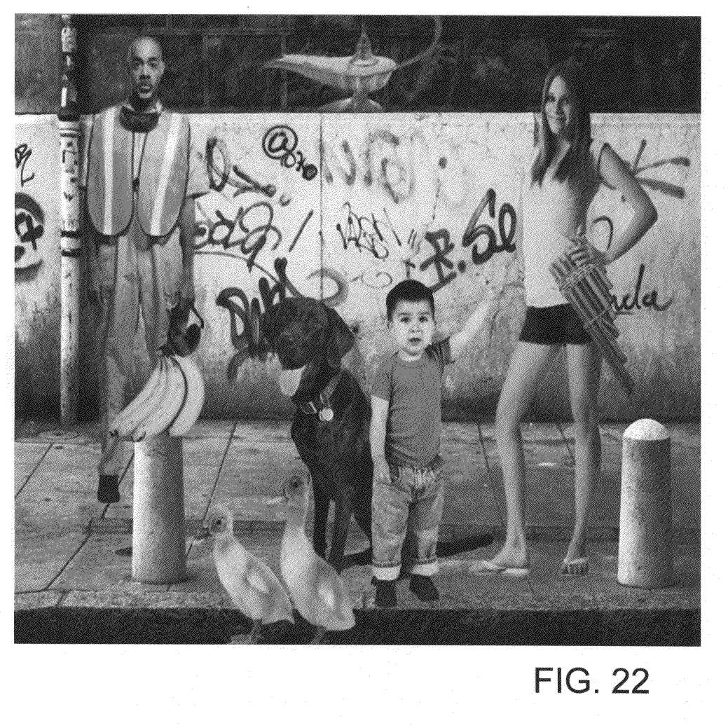

During the encoding phase, each participant viewed the nine character hexadecimal password, as well as the composite image of a composite scene, such as scene 10 in FIG. 7. Other examples of composite scenes are shown in FIGS. 13-22. Participants were told to remember each critical element of the composite scene, and then the nine critical elements of the scene were pointed out to them. Order of presentation was counterbalanced between participants, and each participant viewed the same hexadecimal and graphical passcode. The passcodes were presented for one minute each.

After presentation of the passcodes, participants began practicing on the driving simulator. After practicing for ten minutes, the participants went through the first authentication phase in which they were asked to recall the hexadecimal password and describe the composite image to the best of their ability. Free response was used to assess participants' memory during this first authentication phase so that there would not be a second exposure to the passcode stimuli.

Upon completion of the fifty minute map viewing task, the second authentication phase of the experiment began. For the hexadecimal password, participants were prompted to recite the password. For the graphical passcode, participants were shown the nine response sheets, each with sixteen images arranged in a grid, such as in FIGS. 2-4. The participants were instructed to select the image that they recognized from the composite scene by pointing at it, and each response was recorded. A subset of ten participants returned on average ten days later (minimum of six days later) for a second session of the map viewing task, and the third authentication phase took place in an identical manner to the second. Participants were not instructed to remember the passcodes between sessions, and they were not informed that the passcodes would be tested again during their second simulated driving task.

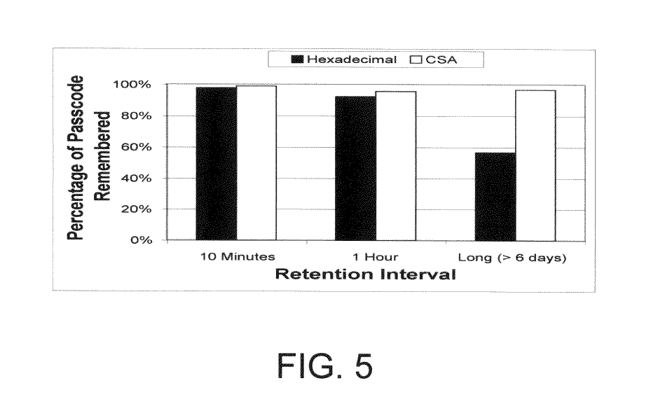

The percentage of the password that was reported correctly was measured in addition to recording whether or not the participant's response would result in a successful login on the first attempt. Table 1 shows the response patterns for participants after each retention interval. The data show that for the shorter retention intervals, there was no significant difference in participants' ability to recall the hexadecimal password versus the graphical passcode. As shown in FIG. 5, participants were able to recognize the images better than they could recall the hexadecimal password for the long retention interval. The within-subjects manipulations of passcode (hexadecimal or graphical) and retention interval (10 minutes, 1 hour, >6 days) were analyzed in a 2×3 repeated measures ANOVA. The Greenhouse-Geisser correction was used to account for any violation in the assumption of equal variances. There was a significant main effect found for both passcode type, F(1,9)=13.41, p=0.005, and retention interval, F(1.24,11.15)=11.05, p=0.005. A significant interaction effect was also found between the passcode type and retention interval, F(1.11,10)=9.25, p=0.011. Table 1 provides mean percent of passcode correctly identified and total number of successes and failures per type of passcode and length of retention interval. Figures in parentheses reflect data only for the 10 participants that returned for the third authentication phase.

TABLE 1

| | | |
|---|---|---|
| % Correct | Success | Failure |

10 Minute Retention Interval

| | | | |
|---|---|---|---|
| Hexadecimal Password | (97.8) 95.4 | (9) 19 | (1) 5 |
| Graphical Passcode | (98.9) 95.9 | (9) 17 | (1) 7 |

1 Hour Retention Interval

| | | | |
|---|---|---|---|
| Hexadecimal Password | (92.3) 90.3 | (7) 16 | (3) 8 |
| Graphical Passcode | (95.6) 91.3 | (7) 13 | (3) 11 |

Long Retention Interval

| | | | |
|---|---|---|---|
| Hexadecimal Password | 56.6 | 2 | 8 |
| Graphical Passcode | 96.7 | 8 | 2 |

Although participants did not differ significantly in their ability to recall or recognize the different types of passcodes in the shorter retention intervals (≦1 hour), composite scenes with meaningful interactions led to a marked advantage for passcode memorability for the long retention interval (≧6 days). Although only a small number of participants (n=10) returned for the second session of the experiment, the rate of 80% correct authentications (at first try) with the graphical passcode is quite high (the hexadecimal rate was 20%). This is especially true given the lack of instructions to remember the passcode after the first session, and the lack of rehearsal during the retention interval. In comparison, De Angeli et al. (2005) found a successful authentication rate (at first try) for their graphical passcode of approximately 47%¹ after a one week retention interval, using a much shorter passcode as well as multiple authentication practices during encoding. ¹ This figure is a best-case-scenario estimate based on the published data.

Percentage of information accurately reproduced for the graphical passcode remains relatively constant between the one hour and longer retention intervals (95.6% and 96.7% respectively), whereas this figure is nearly cut in half for the hexadecimal passcode (92.3% and 56.6% respectively). These results establish that memorable passcodes of significant bit-length can be generated using composite scenes having meaningful interactions.

A larger number of randomly selected passcodes, and an increased number of participants, currently are being used to directly compare scene-based versus sequentially-presented visual material. Graphical information presented as composite scenes likely will show superior memorability compared to independent presentation of visual items, such as the ones used in VIP (De Angeli, et al., 2005) or Déjà (Dhamija & Perrig, 2000), neither of which employ the use of composite scenes during encoding to aide in the memorability of the graphical passcode.

### B. Example 2

This example compared three different embodiments of the presently disclosed composite scene authentication with three prior art graphical authentication systems. All systems were implemented at the same level of security (complexity), thus allowing for direct comparison.

Participants were mostly undergraduate students drawn from the University of Idaho subject pool. Valid data was received from 252 participants for the 30 minute interval, from 223 participants for the 1 week interval, and from 163 participants after 3 weeks. All participants had normal or corrected to normal vision, and reported no history of severe memory impairments of any kind. All participated either for course credit or a chance of winning a cash prize.

Each participant was presented one traditional alphanumeric password and one graphical passcode of equal complexity in one of 6 different conditions (see below). Password complexity was varied between participants (36 bits vs. 46.5 bits). Manipulation of passcode complexity was achieved by reducing the size of the authentication grids from 6×6 elements to 4×4 elements for about half of the participants.

The ability of users to remember an arbitrarily assigned graphical passcode as well as an arbitrarily assigned alphanumeric password was tested at three retention intervals: 30 minutes, 1 week, and 3 weeks. A short story memory test was used to occupy participants during the 30 minute interval.

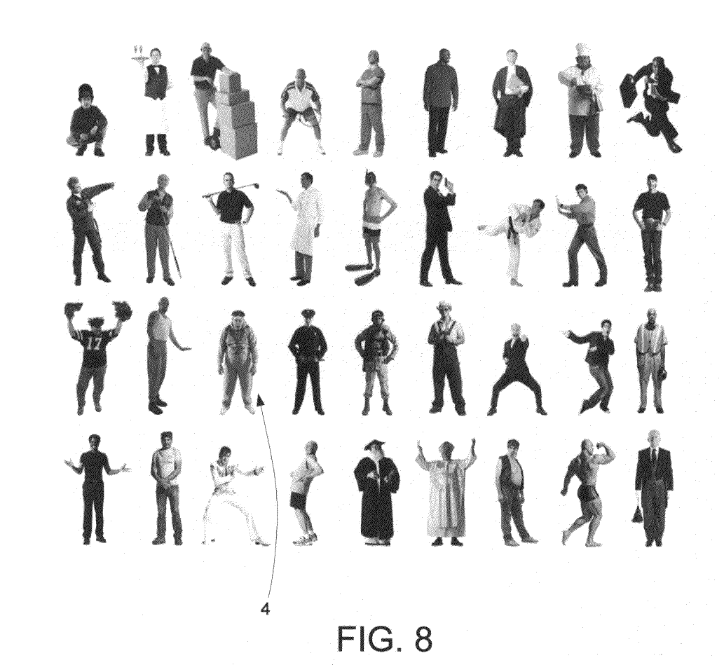

An example of a composite scene passcode used in the study is depicted in FIG. 7. Other examples of a composite scene passcode are shown in FIGS. 13-22. Referring again to FIG. 7, the picture to be remembered 10 is composed of nine elements 1, 2, 3, 4, 5, 6, 7, 8, 9. The elements includes a distinct background (great wall of China) 1 and includes eight distinct additional elements (a large gong 2, a tomato 3, an adult male in sweat pants 4, an, an adult female in a black dress 5, a boy 6, a rooster 7, a dog 8, and a sea shell 9). The set of male figures in FIG. 8 depicts a selection set that was presented during authentication after the image was learned. The users' task was to select the correct scene element out of the set of distracters. In this case, the male in sweats 4 was part of the original picture and would be the correct choice.

Three different versions of composite scene authentication were implemented. In the “composite” condition, participants only saw the composite scene 10 as depicted above in FIG. 7 for ninety seconds. In a “serial” presentation version of the same passcode, participants saw each element 1, 2, 3, 4, 5, 6, 7, 8, 9 of the scene for ten seconds apiece—for a total exposure time of ninety seconds. In the “serial+composite” condition, participants first saw each element 1, 2, 3, 4, 5, 6, 7, 8, 9 for five seconds to accustom them with the scene elements, and then saw the composite scene 10 for the remaining forty-five seconds to integrate the elements into a coherent scene. We expected the serial+composite condition to show the highest memory performance because the individual elements 1, 2, 3, 4, 5, 6, 7, 8, 9 are clear and distinct during serial presentation and interactions/relations between elements are present in the composite presentation.

Beyond the three versions of the presently disclosed composite scene authentication, three prior art graphical authentication systems were included in the study. First, a tiled condition was used, where participants were presented with a tiled 3×3 grid of the nine relevant elements 101, 102, 103, 104, 105, 106, 107, 108, 109, as seen in FIG. 9. This 3×3 grid presents participants with all the elements, but does not include meaningful interactions or relations among the elements. During the authentication phase, participants have to indicate the target element out of a set of distracters, similarly to composite scene authentication. However, unlike some embodiments of composite scene authentication, the elements are not categorically organized during the authentication phase. Instead, elements of different categories are mixed together in the authentication grid 100. This increases the difficulty of the search task for the correct element.

Second, an additional 324 images of faces were used to simulate a graphical authentication mechanism that relies on facial recognition, modeled after the Passfaces™ system. The facial images were gathered from royalty-free collections available online. Enrollment and authentication were similar to the tiled and composite scene conditions. Participants were presented with a 3×3 grid of nine faces for ninety seconds, during which they had to submit the faces to memory. During authentication, participants were presented nine authentication grids from which they had to choose one face per screen they had seen during enrollment. The grids were organized by gender and age to mimic the composite scene authentication approach.

Third, to simulate a spatial authentication mechanism with similar complexity as the other passcodes tested, we divided an image of a natural scene 110 into a regular 6×6 (or 4×4 for lower complexity) grid and randomly chose a sequence of nine locations 112 as target locations, as shown in FIG. 10. Participants learned the sequence of nine locations by watching a dot 114 highlight the target positions within the sequence. After two such repetitions, participants were asked to reproduce the sequence. Participants exited the enrollment phase only after they were able to reproduce the sequence twice without a mistake. Through pilot testing we had noticed that participants required substantially more time and practice to learn arbitrarily assigned spatial passcode sequences than any other authentication system, which led to the change in enrollment procedure.

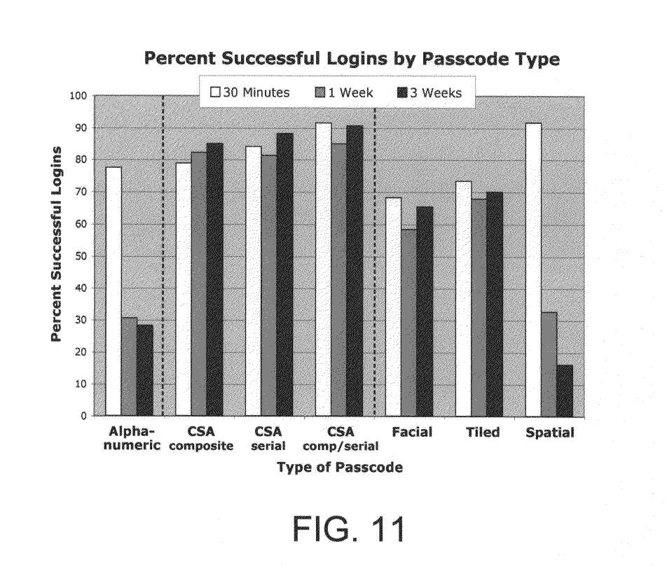

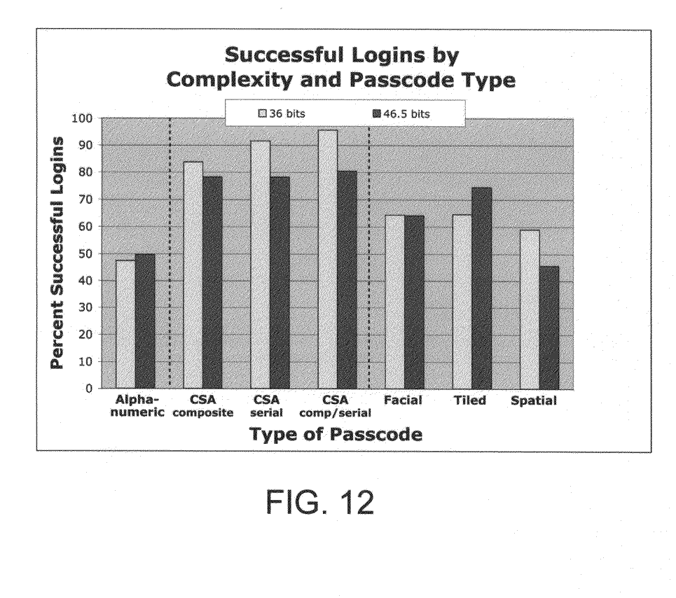

Results of this study are shown in FIGS. 11-12. As seen in FIG. 11, the percentage of successful logins using traditional alphanumeric passwords decreased dramatically between the initial 30 minute retention of the password and the 1 week and 3 week retentions. Whereas 78% of all participants were initially able to successfully reproduce the alphanumeric password correctly given three different attempts, the percentage dropped to 31% and 28% after 1 week and 3 week retention intervals, respectively.

Graphical passcodes overall did much better, with the exception of the spatial passcode, which initially was successfully remembered by 92% of participants, but dropped to 33% and 26% for the longer retention intervals. The exceptional performance after 30 minutes most likely is an artifact of the enrollment process in this condition, as participants were trained to reproduce the sequence twice without a mistake in this condition, while only being passively exposed to the visual presentations of passcodes in the other conditions.

Among the remaining graphical passcodes, all three versions of composite scene authentication significantly outperformed both the facial and the tiled systems. For the facial passcode, performance was reliably between 60-68% successful logins, whereas performance for the tiled system as implemented was around 70%. Participants in the composite scene groups, in contrast, were able to successfully authenticate between 79-92% of the time, with the serial+composite group showing the best performance overall with successful authentication rates right around 90%.

As evident from FIG. 12, an increase in complexity of the different graphical passcodes leads to a general decrease in the ability to authenticate successfully. The drop of approximately 10% in success rate still leaves most graphical systems above the level of the traditional alphanumeric password system. Since these data are collapsed across all retention intervals, the large benefit of recognition-based systems over recall-based traditional passwords and spatial sequences is diluted by the high level of performance on these systems for the 30 minute retention interval. It is likely that the increase in memorability for higher complexity passcodes in the tiled condition is a statistical aberration and not due to an intrinsic advantage of higher complexity for this type of passcode. From the present data it seems that bit-lengths of 36 bits are very practical for typical users. Higher complexities can still benefit from a refinement of the scene dimensions used, as well as the sets of images within each scene dimension that are being presented. Finally, complexity can, of course, also be increased by adding additional scene dimensions (more image elements within a passcode). Even at 46.5 bits, user performance on composite scene based passcodes was quite impressive at near 80% successful authentication rates.

It is our hypothesis that the benefit of the composite scene presentation in the serial+composite, condition, which was not large compared to the serial presentation alone, should be more evident if two or more passcodes have to be remembered. In these situations, the binding of the individual scene elements into a cohesive unit is of even greater importance than in the single-passcode situation studied here. We therefore expect the current composite scene system to perform even better in situations where more than one passcode needs to be remembered.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A process for creating a composite scene passcode, comprising presenting a system-generated composite scene passcode to a user, allowing the user to generate a composite scene passcode by selecting at least one scene element per scene dimension, where the user's resulting customized composite scene passcode is later presented to the user, or allowing the user to enter an alphanumeric password that determines a composite scene passcode which is later presented and uniquely identifies the alphanumeric password.

2. The method according to claim 1 further comprising presenting the user one or more sets of potential scene elements for each scene dimension, and allowing the user to choose at least one scene element for each dimension.

3. The method according to claim 1 where a random string of n characters forms the password, with each of the characters representing a choice out of a set of all possible characters at the particular position within the string.

4. The method according to claim 3 where the password is translated into the composite scene passcode by mapping alphanumeric elements of the password to corresponding scene elements.

5. The method according to claim 1 further comprising combining the passcode with an alphanumeric password.

6. The method according to claim 1 where the scene elements are further conditionally related to another scene dimension.

7. The method according to claim 1 further comprising placing individual scene elements into a multidimensional composite scene at predefined locations within the composite scene, where stored or inferred dependencies between scene elements and scene element placement constraints are applied.

8. The method according to claim 7 where placement, location, size, orientation, and/or particular instantiation of scene elements are determined by stored or inferred constraints via constraint satisfaction algorithm.

9. The method according to claim 1 further comprising placing individual scene elements into a three dimensional scene at locations and orientations within the scene according to stored or inferred dependencies between scene elements and the scene is rendered from one or multiple different viewpoints to provide the composite scene passcode.

10. The method according to claim 9 where placement, location, size, orientation, viewpoint, and/or particular instantiation of scene elements are determined by a constraint satisfaction algorithm.

11. The method according to claim 1 further comprising accompanying presentation of the composite scene passcode with other techniques designed to facilitate passcode retention.

12. The method according to claim 11 where presentation of the composite scene is accompanied by a presentation of spatially or temporally separated scene elements that need to be remembered.

13. The method according to claim 1 further comprising:
generating an alphanumeric password; and
presenting the alphanumeric password either synchronously or sequentially with the composite scene.

14. The method according to claim 13 where all or a subset of the composite scene passcode uniquely identifies all or a subset of the alphanumeric password.

15. The method according to claim 13 where each scene element in each scene dimension corresponds to a unique character in the alphanumeric password.

16. The method according to claim 1 further comprising
entering of a user identification by the user; and
presenting a composite scene password challenge by a system, where the system iteratively moves through at least one of the n* dimensions of the passcode presenting image elements, the user selects image elements that form a concatenated composite scene passcode, and the concatenated passcode is checked against at least part of a stored passcode associated with the user.

17. The method according to claim 13 further comprising using a composite scene passcode recognition process to regenerate all or a portion of the alphanumeric password, where the user can complete the alphanumeric password at any time during the process without further presentation of additional scene dimensions or scene elements.

18. The method according to claim 1 where allowing the user to generate a composite scene passcode further comprises:
presenting to the user visual elements for each scene dimension used to compose a passcode;
allowing the user to randomly select at least one element for each scene dimension; and
assembling a contextual image passcode using elements selected by the user for each scene dimension presented.

19. The method according to claim 1 further comprising:
displaying a plurality of scene elements for each scene dimension to a user;
requiring the user to select at least one of the plurality of scene elements included in the composite scene or to enter an alphanumeric password that corresponds to the composite scene;
comparing the composite scene or alphanumeric password entered by the user to a stored passcode; and
permitting user access to the system when an entered passcode is identical or substantially identical to a stored passcode for that user.

20. A method for screening access to a system, comprising:
allowing the system or a user to generate a graphical passcode;
allowing the system or user to generate an alphanumeric password; and
generating a mapping between the graphical passcode and the alphanumeric passcode.

21. The method according to claim 20 further comprising requiring the user to enter both the graphical passcode and the alphanumeric password to gain access to the system.

22. The method according to claim 20 where the system is a computer system, automatic teller machine, business access control, cell phone, handheld electronic device, network, or an Internet-based system or service.

23. A method for screening access to a system, comprising:
generating a graphical passcode comprising plural elements;
presenting a plurality of image elements in at least one categorical authentication grid to a user;
selecting image elements that form a graphical passcode; and
comparing the selected passcode elements with a stored passcode.

24. A program stored on at least one machine readable medium for protecting user access to a computer, document, or interne site using a passcode, comprising:
a code segment that displays to a user a composite image comprising a plurality of scene elements;
a code segment that requires the user to select scene elements included in the composite image;
a code segment that compares a passcode entered by the user with a stored passcode; and
a code segment that permits user access when the entered passcode is identical to or substantially identical to the stored passcode.

25. A system, comprising:
a display for displaying a composite scene passcode or plural scene elements for generating the composite scene passcode;
an input device used by a user to input image selection useful for compositing a composite scene passcode, for entering the selections into memory and for reentering the passcode to obtain access to the system; and
a program that uses a composite scene passcode to control user access to some feature, file, element, or functionality of the system.
